(19) United States
(12) Patent Application Publication
(10) Pub. No.: US 2025/0242734 A1
(43) Pub. Date: Jul. 31, 2025

(54) SEAT COVER FOR A SEAT AND SEAT WITH A SEAT CUSION AND SUCH A SEAT COVER

(71) Applicant: Adient US LLC, Plymouth, MI (US)

(72) Inventors: Markus Manfred MÜLLER, Mechernich (DE); Iain BARLOW, Stevenage (GB)

(21) Appl. No.: 19/036,178

(22) Filed: Jan. 24, 2025

(30) Foreign Application Priority Data
Jan. 26, 2024 (DE) 10 2024 200 710.2
May 21, 2024 (DE) 10 2024 204 683.3

(51) Int. Cl. B60N 2/60

(52) U.S. Cl. CPC B60N 2/6027

(57) ABSTRACT

The invention relates to a seat cover, in particular a seamless seat cover, having at least one cover material and a cover holder arranged on the cover material for holding the cover material on a seat cushion. The cover holder has at least two carrier elements which are connected to one another in portions. The carrier elements are on the one hand provided with a fastening element on their carrier portions which are connected to one another and on the other hand are connected by a material bond to a non-visible surface side of the cover material which faces away from a visible surface side of the cover material on their opposite carrier portions which are not connected to one another. A seat having the seat cover is also provided.

### FIELD

The invention relates to a seat cover comprising at least one cover material and a cover holder, as well as to a seat, in particular a vehicle seat.

### BACKGROUND

A seat, such as a vehicle seat, is usually provided with a seat cover. It is also known to detachably fasten the seat cover to the seat, for example to remove or replace the seat cover.

The invention is based on the task of improving a seat cover of the type mentioned at the outset, in particular to make it seamless, and to provide a corresponding seat, in particular a vehicle seat.

### SUMMARY

With regard to the seat cover, the problem is solved in accordance with the invention by the features specified in claim 1. With regard to the seat, the problem is solved in accordance with the invention by the features specified in claim 7.

The problem is solved in accordance with the invention by a seat cover comprising at least one cover material and a cover holder arranged on the cover material for holding the cover material on a seat cushion, wherein the cover holder comprises at least two carriers which are connected to one another in portions and which are provided with at least one fastening element on their carrier portions which are connected to one another and are each connected, in particular by a material bond, for example glued, to a non-visible surface side of the cover material which faces away from a visible surface side of the cover material on their carrier portions which are not connected to one another.

The fact that the cover holder comprises at least two carriers connected to one another in portions, which are provided with at least one fastening element on their connected carrier portions and are each connected to the cover material on their unconnected carrier portions, means that the cover holder can be connected to the seat cushion on the one hand and to the cover material on the other in a simple manner.

In other words, the carrier elements are connected to one another, in particular firmly connected, at a first carrier end on the one hand and connected, in particular firmly connected, to the non-visible surface side of the cover material at the opposite second carrier end on the other hand. The first carrier portions form the first carrier end. The second carrier portions form the second carrier end.

The cover holder is located on the non-visible surface side of the cover material.

The fact that the cover holder is fastened to the non-visible surface side of the cover material by a material bond means that a seamless or seam-free seat cover can be provided to increase seating comfort and enhance the visual appearance. The seat cover can have a flat or planar surface side.

The seat cover according to the invention can be designed in such a way that a cover fastening on a seat cushion can be “hidden”. The cover holder, which is fixed to the cover material by a material bond and in a seamless manner, enables a “hidden downward mounting”, whereby a smooth appearance can be achieved on the A surface of the seat cover without the fastening being visible in the interior.

Advantageous embodiments, which can be used individually or in combination with one another, are the subject of the dependent claims.

The carrier portions of the carriers that are not connected to one another can form connecting surfaces for connection to the seat cover.

The second carrier portions can be designed as free ends and project away from one another in such a way that the second carrier portions, i.e. the second carrier end, have or form a flat connecting surface facing the non-visible surface side of the cover material.

The unconnected second carrier portions can, for example, project away from one another after the connecting area of the connected first carrier portions, in such a way that the second carrier portions form a flat connecting surface facing the non-visible surface side of the cover material.

The fact that each connecting surface of the carrier elements is connected to a non-visible surface side of the cover material facing away from a visible surface side of the cover material, in particular connected by a material bond, for example glued, makes it possible to achieve a seamless surface side and a homogenous outer contour of the cover material without visible joints, dents, seams, weld seams or visible fastenings.

In other words, the seat cover can maintain the smooth appearance of its A-surface.

The carrier elements can each be formed from a layer of nonwoven fabric. The use of carrier elements formed from nonwoven fabric makes it easy to seamlessly fasten the cover holder to the cover material. Furthermore, nonwoven fabric layers can be made robust and comparatively thin, so that the visual appearance is not affected even after the carrier elements have been fastened to the cover material.

The nonwoven fabric layers can be joined together in a first area, in particular at their first carrier portions. The nonwoven fabric layers can be exposed in a second area, in particular forming free second carrier portions.

The carriers can be nonwoven carriers. The carriers can each be formed from a nonwoven material or nonwoven fabric. The carriers can each be formed from a web material, woven fabric, knitted fabric or knitted fabric made of fibers. Carriers formed from nonwoven fabric can be joined together in a simple manner, for example glued and/or sewn. Furthermore, carriers formed from nonwoven fabric can be connected to the cover material in a simple manner, in particular glued.

The second carrier portions can be connected to the non-visible surface side of the cover material via an adhesive layer.

An adhesive layer can be arranged between the cover material and the connecting surfaces of the carriers. For example, an adhesive layer can be applied to the corresponding surface side of the cover material and then connected to the connecting surfaces. Alternatively, or optionally additionally, an adhesive layer can already be applied to the connecting surfaces. In this case, the connecting surfaces of the carriers can already be provided with an adhesive, for example by being impregnated.

The fastening element can comprise at least one connecting hook, a connecting wire, a loop, a pocket, a welting element and/or a connecting ring.

Furthermore, the invention relates to a seat, in particular a vehicle seat, comprising a seat cushion and a seat cover which is detachably fastenable or fastened to the seat cushion and has the above-mentioned features.

The seat cushion can comprise at least one recess with a retaining element arranged in the recess.

The cover holder is introducible or introduced into the recess with its first carrier portions and the fastening element for fastening the seat cover to the seat cushion, wherein the fastening element is engageable or engaged with the retaining element.

The retaining element can comprise at least one retaining clip, a staple ring, a hog ring and/or a retaining wire and/or can be formed by a component of a mat, for example a cushioning mat.

Furthermore, the invention can relate to a method for producing a seat cover having the above-mentioned features.

In a first method step, the carrier elements, for example in the form of nonwoven fabric layers, are joined together via a first carrier portion, for example by means of a pressure joining process at room temperature. In a second method step, free-standing, unconnected carrier portions of the carrier elements, in particular carrier portions opposite the first carrier portion, are folded apart. The second carrier portions are moved apart in such a way that they form a flat connecting surface which is then to be provided with a cover material. The connecting surface is provided with an adhesive layer and/or an adhesive agent and connected by a material bond to the cover material.

### DESCRIPTION OF THE FIGURES

In the following, the invention is explained in greater detail with reference to advantageous exemplary embodiments shown in the figures. However, the invention is not limited to these exemplary embodiments. The figures show:

FIG. 1: a schematic representation of a vehicle seat with at least one seat cushion provided with a seat cover,

FIG. 2: a sectional view of a seat cushion provided with a seat cover according to a first exemplary embodiment,

FIG. 3: a sectional view of a seat cushion provided with a seat cover according to a second exemplary embodiment, and

FIG. 4: a sectional view of a seat cushion provided with a seat cover according to a third exemplary embodiment.

### DETAILED DESCRIPTION

Corresponding parts are provided with the same reference signs in all figures.

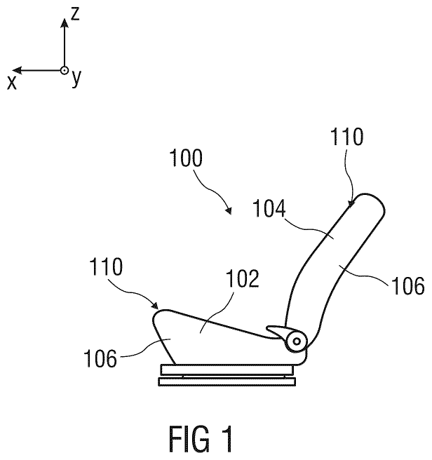

A vehicle seat 100 shown schematically in FIG. 1 is described below using three spatial directions running perpendicular to one another. In a vehicle seat 100 installed in the vehicle, a longitudinal direction x runs largely horizontally and preferably parallel to a longitudinal direction of the vehicle, which corresponds to the usual direction of travel of the vehicle. A transverse direction y running perpendicular to the longitudinal direction x is also horizontally oriented in the vehicle and runs parallel to a transverse direction of the vehicle. A vertical direction z runs perpendicular to the longitudinal direction x and perpendicular to the transverse direction y. In the case of a vehicle seat 100 installed in the vehicle, the vertical direction z preferably runs parallel to a vehicle vertical axis.

The position information and directional information used, such as front, rear, top and bottom, refer to a viewing direction of an occupant sitting in the vehicle seat 100 in a normal sitting position, wherein the vehicle seat 100 is installed in the vehicle, in a position of use suitable for passenger transportation with the backrest 104 upright and oriented as usual in the direction of travel. However, the vehicle seat 100 can also be installed or moved in a different orientation, for example transverse to the direction of travel. Unless otherwise described, the vehicle seat 100 is constructed with mirror symmetry with respect to a plane extending perpendicular to the transverse direction y.

The backrest 104 can be pivotably arranged on a seat part 102 of the vehicle seat 100.

The vehicle seat 100 comprises at least one seat cushion 106, for example a foam part. The seat cushion 106 is provided with a seat cover 110. The seat cover 110 can, for example, be formed from a textile, a leather or another natural material or natural fabric.

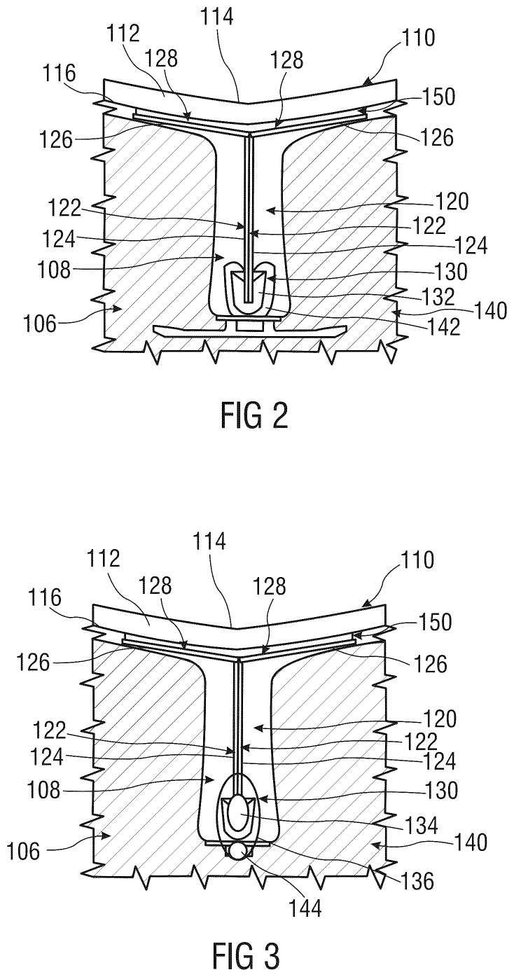

FIG. 2 shows a sectional view of a seat cushion 106 provided with a seat cover 110.

The seat cushion 106 comprises at least one recess 108. The seat cushion 106 can have several recesses 108. The recesses 108 can, for example, be formed into one or more channels.

The seat cushion 106 can be a seat part cushion and/or a backrest cushion. The indentation 108 or indentations 108 can be formed into a foam part.

The recess 108 or recesses 108 can each define an attachment receptacle for attaching the seat cover 110 and receiving a cover holder 120 disposed on the seat cover 110.

The seat cover 110 comprises at least one cover material 112 and at least one cover holder 120 disposed on the cover material 112 for retaining and fastening the cover material 112 to the seat cushion 106. The cover material 112 can be formed from, for example, a textile, a leather or other natural material or natural fabric. The cover material 112 can, for example, comprise several cover layers joined together.

The cover material 112 has a visible surface side 114 (also referred to as the A surface) and a surface side 116 (also referred to as the B surface) that is not visible to an occupant. The cover material 112 is applied to the seat cushion 106 in such a way that the visible surface side 114 faces upwards or towards an occupant and the non-visible surface side 116 faces the seat cushion 106.

The cover holder 120 comprises at least two carriers 122, also referred to as carrier elements 122, which are connected to one another in portions. The carriers 122 or carrier elements 122 can each be nonwoven carriers. The carriers 122 can each be formed from a nonwoven material or a nonwoven fabric. The carriers 122 can each be formed from a web material, woven fabric, knitted fabric or knitted fabric made of fibers.

For example, the carriers 122 can each be formed from an extruded nonwoven. The carriers 122 can be spunbonded nonwovens. The carriers 122 can be homogenous, uniformly planar nonwoven layers. The extrusion process is a process for forming a homogenous, uniformly planar nonwoven. The carriers 122 can form an extruded double nonwoven layer.

The carriers 122 each have a first, for example lower, carrier portion 124 and an adjacent second, for example upper, carrier portion 126. The first carrier portions 124 form a first carrier end of the cover holder 120 and the second carrier portions 126 form a second carrier end of the cover holder 120.

The carriers 122 are firmly connected to one another at their first carrier portions 124. For example, the first carrier portions 124 can be connected to one another at least by a material bond and/or in a force-fitting manner. For example, the first carrier portions 124 can be glued and/or sewn together.

The interconnected first carrier portions 124 are provided with at least one fastening element 130. The fastening element 130 can be a connecting hook 132. The fastening element 130 can have a substantially oval-shaped main body and, for example, two hook elements projecting from the main body.

The fastening element 130 can be designed as a so-called “listing pocket”, for example in the form of a loop or pocket, and can have a fastening wire arranged therein.

To fasten the seat cover 110 to the seat cushion 106, the fastening element 130 can be inserted into the recess 108 provided for this purpose and connected, for example clipped or hooked, to a retaining element 140 arranged in the recess 108. The retaining element 140 can be foamed into the seat cushion 106. The retaining element 140 can, for example, be a retaining clip 142, such as a bracket element, clamping element, clip element, hook element, a staple ring or a so-called hog ring.

The carriers 122 are not connected to one another at their second carrier portions 126, that is, they are separated from one another. The second carrier portions 126 are formed as free ends. The carriers 122 are each able to be connected or are connected to the cover material 112 at their second carrier portions 126, which are not connected to one another.

In particular, the fastening holder 120 is connected via the second carrier portions 126 to the non-visible surface side 116 of the cover material 112 facing away from the visible surface side 114 of the cover material 112, in particular is connected by a material bond, for example glued.

Because the second carrier portions 126 are not connected to one another, they can each form a connecting surface 128 suitable for fixed connection to the cover material 112.

The second carrier portions 126 are directed away from one another or folded in such a way that a surface of the second carrier portion 126 facing the cover material 112 forms a connecting surface 128 for connection to the cover material 112 and a surface facing away from the cover material 112 forms a support surface for support on the seat cushion 106 and covering of the recess 108 of the seat cushion 106.

A surface of the respective second carrier portion 126 facing the seat cushion 106 can rest on the seat cushion 106 in the region of the recess 108. The recess 108 can be completely covered by the second carrier portions 126 projecting away from one another.

The connecting surfaces 128 are each connected to the non-visible surface side 116 of the cover material 112 facing away from the visible surface side 114 of the cover material 112, in particular connected by a material bond, for example glued.

An adhesive layer 150 can be arranged between the cover material 112 and the second carrier portions 126, in particular their connecting surfaces 128. The second carrier portions 126 can already be provided with an adhesive, for example impregnated.

The cover material 112 and the carriers 122 can be connected to one another by pressure, for example at room temperature. The cover material 112 can then be secured to the seat cushion 106 using the cover holder 120. For example, the cover material 112 can be fastened to the seat cushion 106 with the cover holder 120 using conventional fastening methods, for example using rings and/or clips. The cover holder 120 enables a so-called “hidden pull down”, whereby a smooth appearance can be realized on the A-surface of the seat cover 110 without the fastening being visible in the interior.

In an alternative exemplary embodiment, the carriers 122 can be formed in one part. In other words, the cover holder 120 can comprise a single carrier 122, which can comprise a first carrier portion 124, which can be provided with the fastener 130, and a second carrier portion 126 adjacent to the first carrier portion 124, wherein the second carrier portion 126 can be divided into two connecting surfaces 128 by a separation process. The carrier 122 can be an extruded nonwoven carrier.

FIG. 3 shows a sectional view of a seat cushion 106 provided with a seat cover 110 according to a second exemplary embodiment.

The connected first carrier portions 124 are provided with at least one fastening element 130. The fastening element 130 can be a welting element 134, for example a round or oval-shaped welting element 134.

To fasten the seat cover 110 to the seat cushion 106, the fastening element 130 can be inserted into the recess 108 provided for this purpose and connected, for example clipped or hooked, to a retaining element 140 arranged in the recess 108. The retaining element 140 can be foamed into the seat cushion 106. The retaining element 140 can, for example, be a retaining wire 144.

The welting element 134 can be fastened to the retaining wire 144 by means of a connecting ring 136. The connecting ring 136 can surround the welting element 134 and the retaining wire 144.

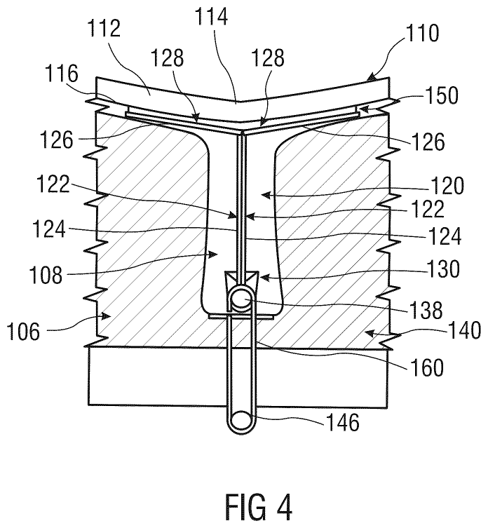

FIG. 4 shows a sectional view of a seat cushion 106 provided with a seat cover 110 according to a third exemplary embodiment.

The connected first carrier portions 124 are provided with at least one fastening element 130. The fastening element 130 can be a connecting wire 138, for example a PP wire and/or metal wire.

To fasten the seat cover 110 to the seat cushion 106, the fastening element 130 can be inserted into the recess 108 provided for this purpose and connected, for example clipped or hooked, to a retaining element 140 arranged in the recess 108. The retaining element 140 can be foamed into the seat cushion 106. The retaining element 140 can, for example, be formed by a component, for example a wire component and/or strip component of a mat 146, for example a flex mat, a suspension mat and/or a cushioning mat.

The connecting wire 138 can be fastened to the mat 146 by means of a connecting clip 160, for example a plastic clip, which is passed through the foam of the seat cushion 106. The connecting clip 160 can enclose the connecting wire 138 and a component of the mat 146.

### List of Reference Signs

100 vehicle seat
102 seat part
104 backrest
106 seat cushion
108 recess
110 seat cover
112 cover material
114 surface side, in particular visible surface side
116 surface side, in particular non-visible surface side
120 cover holder
122 carrier, in particular carrier element
124 first carrier portion
126 second carrier portion
128 connecting surface
130 fastening element
132 connecting hook
134 welting element
136 connecting ring
138 connecting wire
140 retaining element
142 retaining clip
144 retaining wire
146 mat
150 adhesive layer
160 connecting clip
x longitudinal direction
y transverse direction
z vertical direction

1. A seamless seat cover, comprising at least one cover material and a cover holder arranged on the cover material for holding the cover material on a seat cushion, wherein the cover holder comprises at least two carrier elements connected to one another in portions,
characterized in that the carrier elements
on the one hand are provided with a fastening element on their carrier portions which are connected to one another and
on the other hand are connected by a material bond to a non-visible surface side of the cover material which faces away from a visible surface side of the cover material on their opposite carrier portions which are not connected to one another.

2. The seat cover as claimed in claim 1, characterized in that the second carrier portions are designed as free ends and project away from one another in such a way that the second carrier portions have/form a flat connecting surface facing the non-visible surface side of the cover material.

3. The seat cover as claimed in claim 1, characterized in that the second carrier portions are connected to the non-visible surface side of the cover material via an adhesive layer.

4. The seat cover as claimed in claim 1, characterized in that the first carrier portions are connected to one another at least by a material bond.

5. The seat cover as claimed in claim 1, characterized in that the carrier elements are each formed from a nonwoven fabric layer.

6. The seat cover as claimed in claim 1, characterized in that the fastening element comprises at least one connecting hook, a connecting wire, a loop, a pocket, a welting element and/or a connecting ring.

7. A seat comprising at least one seat cushion and a seat cover fastenable or fastened to the seat cushion as claimed in claim 1.

8. The seat as claimed in claim 7, characterized in that the seat cushion comprises at least one recess with a retaining element arranged in the recess.

9. The seat as claimed in claim 8, characterized in that the cover holder with its first carrier portions and the fastening element for fastening the seat cover to the seat cushion is introducible or introduced into the recess, wherein the fastening element is engageable or engaged with the retaining element.

10. The seat as claimed in claim 8, characterized in that the retaining element comprises at least one retaining clip, a staple ring, a hog ring and/or a retaining wire and/or is formed by a wire component and/or a strip component of a mat.
